(19) United States
(12) Patent Application Publication
(10) Pub. No.: US 2007/0262973 A1
(43) Pub. Date: Nov. 15, 2007

(54) Architecture for remote displaying system

(75) Inventor: Min-Chuan Wan, Hsinchu City (TW)

Correspondence Address: John Chen, Room 303, 3F., No 25, Sec. 1, Changan E. Road, Taipei, 10441, TW

(73) Assignee: XGI Technology Inc.

(21) Appl. No.: 11/432,538

(22) Filed: May 12, 2006

(51) Int. Cl. G09G 5/00

(52) U.S. Cl. 345/204

(57) ABSTRACT

The present invention provides an architecture for a remote displaying system comprising a computing system and a displaying system. The computing system comprises a wireless transceiver unit to transmit a control signal for generating display content and receive a response signal from another wireless transceiver unit. The displaying system comprises a wireless transceiver unit, a GPU enable to be electrically connected to a display. The transceiver unit receives the control signal for the GPU to generate the display content to output to the display. The GPU also generates a response signal and the wireless transceiver unit transmits the response signal.

### BACKGROUND OF THE PRESENT INVENTION

1. Field of Invention

The invention relates to remote display, and more particularly to a remote display with low bandwidth communication.

2. Description of Related Arts

A computing device comprises a small video display for the convenience to carry. Once back to the interior environment, the dimensions of the small display are a product liability for a user. For example, a user would like to have a display with larger dimensions when working at office or home.

There are tow ways to resolve the problem. One is a direct cabled connection from GPU output interface to a display, and the other is the communication over a wireless data link from GPU output to a display. The direct cabled connection only drives the display locally within a limited range. And the communication over a wireless data link, which can replace the physical cable, encounters a problem of huge bandwidth of vast data transmission.

U.S. Pat. No. 6,580,422 discloses a technique to minimize the data link bandwidth. Referring to FIG. 1, a portable computing device 101 transmits graphics primitives over a wireless data link 103 to a data link receiver 105. The data link receiver 105 is connected to a large remote computer display 107. Graphics primitives are high level instructions to tell a graphics display how to draw. The wireless data link transmits the high level instructions instead of the images; therefore the bandwidth can be minimized.

But the technique disclosed in U.S. Pat. No. 6,580,422 cannot resolve the problem coming with the 3D real-time rendering. There is a need to provide a technique to minimize the bandwidth more efficiently which is generated not only by the bitmap but also by the rendering, lighting, and texture and so on.

### SUMMARY OF THE PRESENT INVENTION

An object of the present invention is to provide an architecture to reduce the bandwidth of the wireless transmission for remote displaying.

Accordingly, in order to accomplish the one or some or all above objects, the architecture comprises a computing system with a wireless transceiver unit to transmit the wireless control signals to a remote displaying system. The remote displaying system comprises another wireless transceiver unit to communicate with the computing system, a GPU to execute the control signal to generate display content and show it on a display.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 illustrates a remote displaying system in accordance with a prior art.

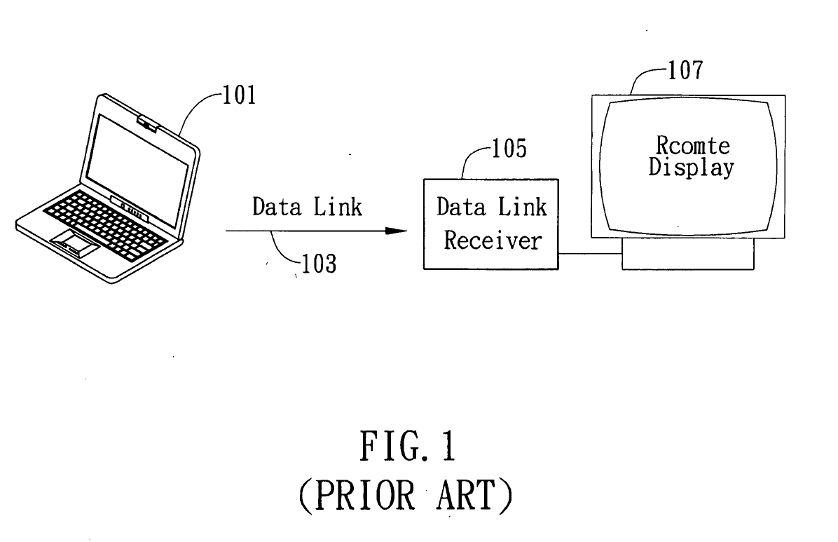

FIG. 2 illustrates an embodiment of the present invention.

FIG. 3 illustrates another embodiment of the present invention.

FIG. 4 illustrates another embodiment of the present invention.

### DETAILED DESCRIPTION OF THE PREFERRED EMBODIMENT

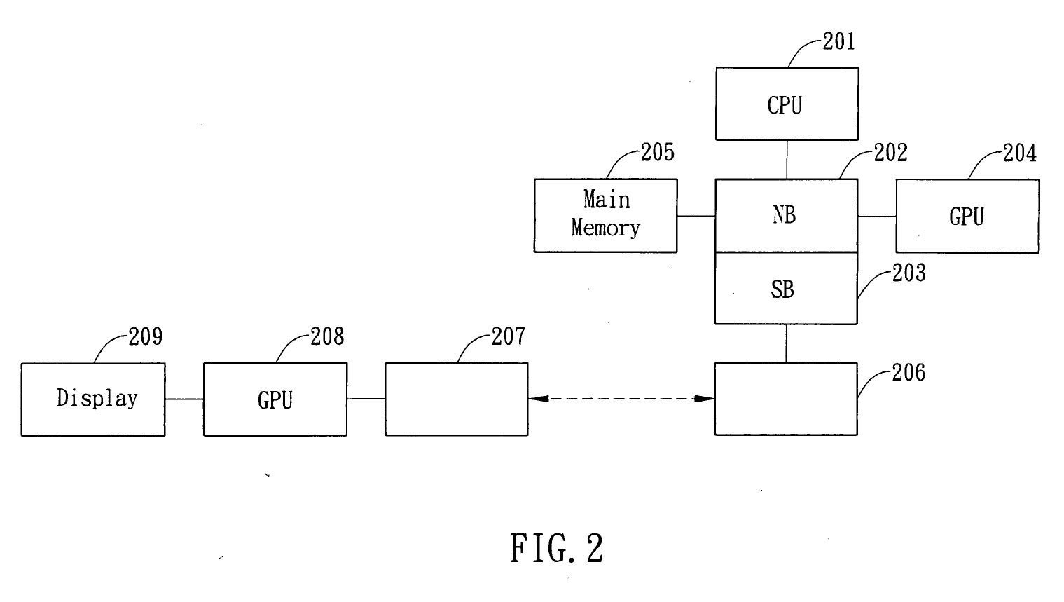

Referring to FIG. 2, it is an embodiment of the present invention to illustrate a remote displaying architecture. The devices 201-205 are a part of a computing system. A bridge chipset comprises a north bridge (NB) 202 and a south bridge (SB) 203. The NB 202 is electrically connected to a CPU 201, a graphics processing unit (GPU) 204, and a main memory 205. The SB 203 is electrically connected to a wireless transceiver unit 206. The devices 207-208 are a part of a remote displaying system. A GPU 208 is electrically connected to a wireless transceiver unit 207 and a display 209. The display 209 may be a CRT monitor, an LCD, a plasma TV, a projector, or any other kind of display. The GPU 204 and 208 may both comprise a memory, such as a frame buffer (not shown) to store graphics data The GPU 204 may be integrated in the NB 202, or a discreet GPU. Both the transceiver unit 206 and 207 have a bus interface, such as PCI, AGP, PCI-Express, PCI-X and so on.

To display an image on a display, such as when playing a 3D game, there are many real-time actions to take care, like rendering, texture mapping, lighting, shadow effect, etc. To accomplish the actions mentioned above, a CPU has to send control signals to a GPU to execute, and then the GPU generates display content to show on a display. The control signals may be formed as a bus protocol format, such as PCI, AGP, PCI-Express, PCI-X. The control signals may be primitives, the basic units, such as a triangle in 3D, to form a graphic picture comprising vertex information which contains relative attribute data, like corresponding position and color. The control signals may also comprise commands, instructions to control hardware engine for special setting like adding fog on or setting perspective correction. The control signals may also comprise texture data, usually a 2D image date to apply to a triangle and to show up the triangle surface detail. The size of the control signals is much smaller than the display content shown on the display, up to 1:100. Therefore, the present invention can minimize the bandwidth.

In the embodiment, The CPU 201 sends the necessary control signals to the wireless transceiver unit 206 through the NB 202 and SB 203. The wireless transceiver unit 206 converts the control signals from the electrical signals into the electromagnetic wave signals, such as microwave, radio frequency (RF) or optical signals. The optical signals may be infrared light. And then the wireless transceiver unit 206 transmits the control signals to the wireless transceiver unit 207. The wireless transceiver unit 207 converts the received control signals from the electromagnetic wave signals into the electrical signals. The GPU 208 executes the control signals coming from the wireless transceiver unit 207, and then shows the corresponding display content of the control signals on the display 209.

Sometimes, the GPU 208 generates the response signals after executing the control signals. Some applications use the render surface as the texture for next frame. For this case, GPU 208 should send back the display content to NB 202. For example, a scene of rear-view mirror of a car will send back to memory 205 to be as a texture for the purpose of combining with next frame which is the front view of the car. Or some applications will change the vertex data by 3D shader. GPU should send back the data for next scene that using this data. For example, when the vertex data in the frame buffer is going to be changed in the next frame, like enlarging a hand, the vertex data have to be sent back to the system memory 205 for the CPU 201 to recalculate the relative distances among the vertexes.

The response signals are sent to the wireless transceiver unit 207. The wireless transceiver unit 207 converts the response signals from the electrical signals into the electromagnetic wave signals, such as microwave, RF or optical signals. The optical signals may be infrared light. The wireless transceiver unit 207 transmits the response signals to the wireless transceiver unit 206. The wireless transceiver unit 206 converts the received response signals from the electromagnetic wave signals into the electrical signals. And then the response signals are sent to the CPU 201 or the main memory 205 through the SB 203 and the NB 202.

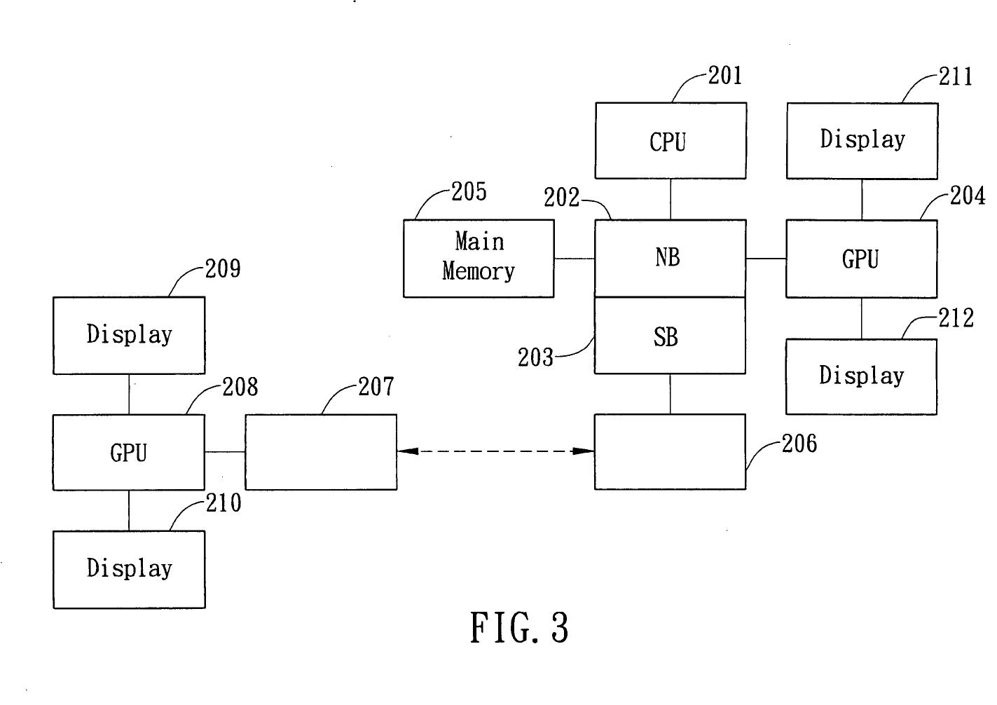

Referring to FIG. 3, it is an embodiment of the present invention to illustrate another remote displaying architecture. FIG. 3 is similar to FIG. 2, except the GPU 208 is electrically connected to the display 209 and 210, and the GPU 204 is electrically connected to the display 211 and 212. The current embodiment is similar to the previous embodiment to operate. Except in the previous embodiment, only the GPU 208 works. But in the current embodiment, both of the GPU 208 and 204 work simultaneously or only the GPU 208 works. The GPU 204 and 208 may receive the same or different control signal to execute to generate display content and sometimes generate response signals.

When a GPU works, there are two modes to select, the mirror mode and the extension mode. When the mirror mode works, the two displays connected to the same GPU display the same image. When the extension mode works, the two displays connected to the same GPU work like one display. In another word, a part of an image is displayed on a display, and the rest of the image is displayed on another display.

When only the GPU 208 works, in the mirror mode, the same image is displayed on the display 209 and 210. In the extension mode, half of an image is displayed on the display 209, and the rest of the image is displayed on the display 210.

When both of the GPU 208 and 204 work simultaneously, the display 209-212 may all display the same image, or the display 209 and 210 display the same image X and the display 211 and 212 display the same image Y but the image X is different from the image Y. Even more, the display 209 and 210 display the same image X and the display 211 displays a part of the image Y and the display 212 displays the rest of the image Y. Or the display 209 displays a part of the image X and the display 210 displays the rest of the image X and the display 211 displays a part of the image Y and the display 212 displays the rest of the image Y.

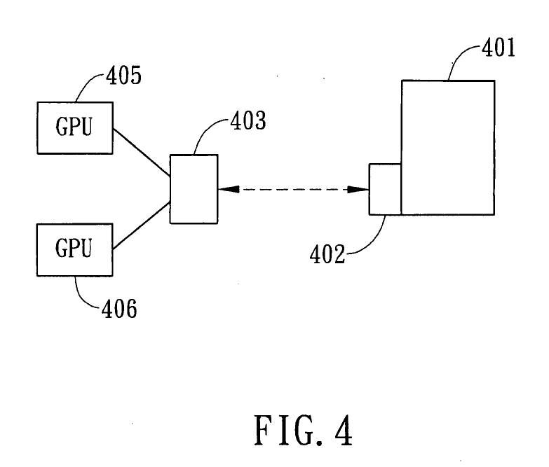

Referring to FIG. 4, a computing system 401 including a transceiver unit 402 to transmit wireless signals to the transceiver unit 403 and receive wireless signals from transceiver unit 403. The transceiver unit 403 is connected to the GPU 405 and GPU 406. The signals coming from the computing system 401 may be sent to 4 displays (not shown). Two displays are connected to the GPU 405, and another two displays are connected to the GPU 406. Foe example, the signals coming from the computing system 401 may comprise Taiwan, Japan, Thailand, and Korean stock market information. Each stock market shows up in a display. Of course, the number of the GPU connected to the transceiver unit 403 may be more than 2.

One skilled in the art will understand that the embodiment of the present invention as shown in the drawings and described above is exemplary only and not intended to be limiting.

The foregoing description of the preferred embodiment of the present invention has been presented for purposes of illustration and description It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An architecture for remote displaying system, comprising:
a computing system comprising a first GPU and a first transceiver unit;
a displaying system comprising a second transceiver unit, a graphics processing unit (GPU) enable to be electrically connected to a display, wherein the GPU is electrically connected to the second transceiver unit;
the first transceiver unit converting an electrical control signal into a wireless control signal, converting a wireless response signal into a electrical response signal, transmitting the wireless control signal, and receiving the wireless response signal;
the second transceiver unit converting an electrical response signal into a wireless response signal, converting a wireless control signal into an electrical control signal, transmitting the wireless response signal, and receiving the wireless control signal; and
the GPU receiving the electrical control signal, generating display content in accordance with the electrical control signal, outputting the display content to the display, and transporting the electrical response signal.

2. The architecture for remote displaying system according to the claim 1, wherein the first transceiver unit transmits the wireless control signal using microwave, radio frequency (RF), or optical signals.

3. The architecture for remote displaying system according to the claim 1, wherein the second transceiver unit transmits the wireless control signal using microwave, radio frequency (RF), or optical signals.

4. An architecture for remote displaying system, comprising:
a computing system comprising a second GPU to generate a third set of display content and a forth set of display content, and a first transceiver unit;
a displaying system comprising a first GPU to generate a first set of display content and a second set of display content and a second transceiver unit;
the first transceiver unit converting a first electrical control signal into a first wireless control signal, converting a wireless response signal into a electrical response signal, transmitting the wireless control signal, and receiving the wireless response signal;
the second transceiver unit converting an electrical response signal into a wireless response signal, converting a wireless control signal into an electrical control signal, transmitting the wireless response signal, and receiving the wireless control signal;
the first GPU receiving the first electrical control signal, generating the first set of display content and the second set of display content in accordance with the first electrical control signal, outputting the first set of display content and the second set of display content, and generating the electrical response signal; and
the second GPU receiving the second electrical control signal, and generating the third set of display content and the forth set of display content in accordance with the second electrical control signal, outputting the third set of display content and the forth set of display content

5. The architecture for remote displaying system according to the claim 5, wherein the first transceiver unit transmits the wireless control signal using microwave, radio frequency (RF), or optical signals.

6. The architecture for remote displaying system according to the claim 5, wherein the second transceiver unit transmits the wireless control signal using microwave, radio frequency (RF), or optical signals.

7. The architecture for remote displaying system according to the claim 5, further comprising a first display to receive the first set of display content, and second display to receive the second set of display content.

8. The architecture for remote displaying system according to the claim 5, further comprising a third display to receive the third set of display content, and forth display to receive the forth set of display content.

9. A computing system, comprising:
a CPU sending an electrical control signal, wherein the electrical control signal is to generate display content by a GPU separate from the computing system;
a bridge circuit electrically connected to the CPU;
a transceiver unit electrically connected to the bridge circuit and receiving the electrical control signal through the interface; and
the transceiver unit converting the electrical control signal into a wireless control signal, converting a wireless response signal into a electrical response signal, transmitting the wireless control signal, and receiving the wireless response signal.

10. The computing system according to the claim 9, wherein the transceiver unit transmits the wireless control signal using microwave, radio frequency (RF), or optical signals.

11. A displaying system, comprising:
a GPU enable to be electrically connected to a display;
a transceiver unit, electrically connected to the GPU, converting an electrical response signal into a wireless response signal, converting a wireless control signal into an electrical control signal, transmitting the wireless response signal, and receiving the wireless control signal; and
the GPU receiving the electrical control signal, generating display content in accordance with the electrical control signal, outputting the display content to the display, and transporting the electrical response signal.

12. The displaying system according to the claim 11, wherein the transceiver unit transmits the wireless response signal using microwave, radio frequency (RF), or optical signals.
